(19) United States
(12) Patent Application Publication
(10) Pub. No.: US 2024/0127658 A1
(43) Pub. Date: Apr. 18, 2024

(54) HIGH-SPEED DEPOSIT APPARATUS

(71) Applicant: Ellenby Technologies, Inc., Woodbury Heights, NJ (US)

(72) Inventors: Thomas J. Carullo, Sewell, NJ (US); Aaron H. Dobbins, Cherry Hill, NJ (US); Luke M. Reilly, Allentown, NJ (US); Bob M. Dobbins, Villanova, PA (US)

(73) Assignee: Ellenby Technologies, Inc., Woodbury Heights, NJ (US)

(21) Appl. No.: 18/486,357

(22) Filed: Oct. 13, 2023

Related U.S. Application Data
(60) Provisional application No. 63/416,739, filed on Oct. 17, 2022.

(51) Int. Cl. G07D 11/00; E05G 1/08; G07D 11/125; G07D 11/225

(52) U.S. Cl. CPC G07D 11/0093; E05G 1/08; G07D 11/125; G07D 11/225; G07D 2207/00

(57) ABSTRACT

A secure smart safe with a high speed validator configured to accept notes in an orderly stack and deposit them into a storage compartment within the safe in orderly stacks for easy retrieval by a cash in transit (CIT) guard. The storage compartment includes a carousel of cash cassettes each containing an orderly stack of validated notes. The arrangement of multiple cash cassettes around the rotatable carousel offer substantial banknote storage capacity in a tight vertical space designed to fit under a counter in a retail shop.

### CROSS-REFERENCE TO RELATED APPLICATIONS

This application claims the benefit of a co-pending, commonly assigned U.S. Provisional Patent Application No. 63/416,739, which was filed on Oct. 17, 2022. The entire content of the foregoing provisional application is incorporated herein by reference.

### TECHNICAL FIELD

The present disclosure relates generally to cash deposit systems, and more particularly to a high-speed deposit apparatus and/or system that facilitates the counting, validating, and safeguarding of cash in a retail environment.

### BACKGROUND

Smart safes have been designed to accept banknotes, electronically validate those banknotes, and then store them in a secure compartment for later retrieval. The retrieval is typically performed by a cash in transit (CIT) service. CIT companies deploy guards to smart safes to bring cash back to central cash counting rooms located at the CIT or bank's vault. There, high-speed cash counting equipment verifies the deposits and matches the value to that reported by the smart safes.

Typical high speed cash counting equipment present in CIT cash vaults, such as those made by Cummins Allison, Giesecke & Devrient, and De La Rue, for instance, requires that banknotes be presented in neat stacks. CIT guards can save substantial preparation time if they retrieve banknotes from a smart safe in an orderly stack.

There are primarily two categories of note stacking technologies widely used on the market today within smart safes: Rigid cassettes and flexible bags.

Rigid cassette mechanisms accept notes one at time through an opening slit in the cassette and get driven onto a spring-loaded pressure plate by a motorized stacking mechanism. This type of cassette is designed to be removable and lockable. To remove the cash, the CIT guard must remove the cassette from the validator, unlock the cassette door, and then grab handfuls of cash pressed tight by the spring-loaded plate. Rigid cassettes like these are ideal for CIT companies desiring to swap full cassettes for empty cassettes and then to remove the banknotes from the full cassette offsite, remote from the smart safe. The drawback of such a system is that rigid cassettes are expensive to produce and their intricate mechanisms are prone to failure if not properly maintained over time.

Flexible bag mechanisms seal neatly stacked banknote deposits in plastic bags. The sealed bags can be removed from the machine by the guards and transported without ruining the neat stack bundle. The bags themselves are disposable and must be replaced at every collection event. Much like the locks that are sometimes used on rigid cassettes, the tamper-evident seal on the flexible bags provides a deterrent for unauthorized access. The disadvantage of flexible bag systems is that they typically require expensive mechanisms inside the safe's secure compartment which are costly to build and to service. Some of these expensive mechanisms can include those used to collect notes in bunches, advance bunches into a bag, properly position the bag with respect to the note bundles, press the bag closed, and heat seal the bag when full.

### SUMMARY

In accordance with embodiments of the present disclosure, an exemplary high-speed deposit apparatus is provided that allows for a lower cost stacking mechanism for smart safes (as compared to traditional systems) that caters to current business practices of removing cash directly at the safe rather than swapping a cash storage container with an empty one. It is an objective of this invention to create orderly stacks of validated banknotes in a storage carousel with a secured storage area for easy retrieval during collection.

It is another objective to create orderly stacks of banknotes by dropping packets of notes a fixed distance onto a moveable platform within a cassette. The moveable platform is configured to move such that each new packet drop falls the same fixed distance prior to hitting the top of the pile.

It is another objective to build a note packet drop ramp of particular geometry and roughness to ensure notes dropped fall in an orderly manner onto a note stack.

It is another objective to control the motion of the moveable platform with a sensor connected to a controller designed to detect the distance between the point of the note packet release to the top of the note stack.

It is another objective to control the moveable platform based with the objective of maintaining a fixed distance between the top of the note stack and the release point of the note packet using the distance sensor. The moveable platform is capable of traveling down past the desired drop distance and then reversing back up for the purpose of compressing the note stack by way of the rubbing friction of the note edges with the cassette sidewall as the moveable platform rises.

It is another objective to use the same sensor for distance detection as a security monitor to ensure the note stack is not tampered with during periods of time when note packets are not dropped onto the note stack.

It is another objective for the high-speed deposit apparatus to provide a note stacking mechanism that fits conveniently under a counter using multiple cassettes.

In accordance with embodiments of the present disclosure, an exemplary method of operating a high-speed deposit apparatus is provided. The method includes lowering the movable platform below the bottom of the cassette once the cassette is filled and then rotating a new empty cassette above the moveable platform to permit storage of additional stacks of notes within the secured storage area.

In accordance with embodiments of the present disclosure, an exemplary note bundle deposit system is provided. The system includes a cassette including a hollow interior configured to receive note bundles. The cassette includes an opening extending from a base of the cassette. The system includes a platform capable of being linearly driven in opposing directions along a path such that the platform moves within the opening of the cassette. The platform includes a top surface configured to support the note bundles. The system includes at least one sensor configured to detect a drop distance of the note bundles. The drop distance defines (i) a distance between the at least one sensor and the top surface of the platform for a first note bundle introduced into the cassette, and (ii) a distance between the at least one sensor and a top surface of an uppermost note bundle supported by the platform for all subsequent note bundles introduced into the cassette. The system includes a controller in communication with the at least one sensor to receive the detected drop distance and adjust a position of the platform along the path such that the drop distance is substantially equal for each note bundle introduced into the cassette.

In some embodiments, the cassette can include a top section and two support sections extending from the top section. The two support sections can be spaced from each other by the opening extending from the base of the cassette. The cassette can include a top section with an inclined ramp configured to engage with the note bundles falling into the cassette. In some embodiments, the inclined ramp can extend at an angle of about 45° relative to horizontal. In some embodiments, the inclined ramp can include a textured surface for frictional engagement with the note bundles falling into the cassette.

In some embodiments, the drop distance can be between about 2.5 inches to about 3.5 inches, inclusive. In some embodiments, the drop distance can be about 3 inches. The platform is capable of being linearly driven to a lowermost position of the path such that the platform is disposed below a plane defined by the base of the cassette. The cassette can be mounted to a carousel rotatably coupled to a carousel base. When the platform is in the lowermost position, clearance is provided between the platform and the cassette for rotation of the carousel.

In some embodiments, the at least one sensor can include a first sensor and a second sensor spaced from each other. Both the first and second sensors are each configured to detect the drop distance. The controller can be configured to detect a discrepancy between the drop distance detected by the first sensor and the drop distance detected by the second sensor. In some embodiments, the at least one sensor can include a Lidar sensor.

In accordance with embodiments of the present disclosure, an exemplary safe is provided. The safe includes an upper compartment configured to receive a validator therein. The safe includes a lower compartment disposed beneath the upper compartment and separated from the upper compartment by a shelf. The shelf includes an opening formed therein and configured to be aligned with the validator. The safe a note bundle deposit system disposed within the lower compartment. The note bundle deposit system includes a cassette including a hollow interior configured to receive note bundles from the upper compartment. The cassette includes an opening extending from a base of the cassette. The note bundle deposit system includes a platform capable of being linearly driven in opposing directions along a path such that the platform moves within the opening of the cassette. The platform includes a top surface configured to support the note bundles. The note bundle deposit system includes at least one sensor configured to detect a drop distance of the note bundles. The drop distance defines (i) a distance between the at least one sensor and the top surface of the platform for a first note bundle introduced into the cassette, and (ii) a distance between the at least one sensor and a top surface of an uppermost note bundle supported by the platform for all subsequent note bundles introduced into the cassette. The note bundle deposit system includes a controller in communication with the at least one sensor to receive the detected drop distance and adjust a position of the platform along the path such that the drop distance is substantially equal for each note bundle introduced into the cassette.

In accordance with embodiments of the present disclosure, an exemplary method of depositing note bundles is provided. The method includes detecting a drop distance of a note bundle with at least one sensor. he drop distance defines (i) a distance between the at least one sensor and a top surface of a platform of the note bundle deposit system for a first note bundle introduced into a cassette of the note bundle deposit system, and (ii) a distance between the at least one sensor and a top surface of an uppermost note bundle supported by the platform for all subsequent note bundles introduced into the cassette. The method includes introducing the first note bundle into the cassette. The cassette includes a hollow interior configured to receive the first note bundle, and the cassette includes an opening extending from a base of the cassette. The method includes receiving the first note bundle on the top surface of the platform. The method includes linearly driving the platform along a path such that the platform moves within the opening of the cassette. The method includes receiving at a controller of the note bundle deposit system the detected drop distance from the at least one sensor. The method includes adjusting a position of the platform along the path such that the drop distance is substantially equal for a subsequent note bundle to be introduced into the cassette.

The method can include driving the platform with the controller to a lowermost position of the path such that the platform is disposed below a plane defined by the base of the cassette. The cassette can be mounted to a carousel rotatably coupled to a carousel base. The method can include actuating rotation of the carousel relative to the carousel base. When the platform is in the lowermost position, clearance is provided between the platform and the cassette for rotation of the carousel.

In accordance with embodiments of the present disclosure, an exemplary note bundle deposit system is provided. The system includes a carousel rotatably mounted to a base. The system includes two or more cassettes mounted to the carousel. Each cassette of the two or more cassettes includes a hollow interior configured to receive note bundles, and each cassette includes an opening extending from a base of the cassette. The system includes a single platform mounted to the base and capable of being linearly driven in opposing directions along a path such that the single platform moves within the opening of a first cassette of the two or more cassettes. The system includes a controller configured to adjust a position of the single platform along the path to a lowermost position such that the platform is disposed below a plane defined by the base of the first cassette. The controller can be configured to rotate the carousel such that the first cassette is moved radially away from the single platform and a second cassette of the two or more cassettes is aligned with the single platform. The controller can be configured to adjust the position of the single platform along the path to a desired position within the opening of the second cassette.

### BRIEF DESCRIPTION OF THE DRAWINGS

FIG. 1 shows a view of an exemplary a high-speed deposit smart safe in the closed and locked configuration, according to the present disclosure.

FIG. 2 shows a view of the high-speed deposit smart safe of FIG. 1 with the top cash deposit compartment opened.

FIG. 3 shows a view of the high-speed deposit smart safe of FIG. 1 with the bottom cash storage compartment opened.

FIG. 4 shows a view of a cash storage carousel assembly of the high-speed deposit smart safe of FIG. 1.

FIGS. 5A and 5B show views of a non-rotating portion of the cash storage carousel assembly of FIG. 4.

FIG. 6 shows a rotatable portion of the cash storage carousel assembly of FIG. 4.

FIGS. 7A and 7B show perspective and side views of a cash storage cassette of the high-speed deposit smart safe of FIG. 1.

FIG. 8A shows a perspective view of a drop zone between a cash deposit compartment and a cash storage compartment of the high-speed deposit smart safe of FIG. 1, and FIG. 8B shows a diagrammatic side view of a cash bundle dropping into a cash cassette of the high-speed deposit smart safe of FIG. 1.

FIG. 9 shows a top-down view of a drop zone area of the high-speed deposit smart safe of FIG. 1 with a deposit control board illustrated as semi-transparent for visibility purposes.

FIG. 10 shows a view of a deposit controller of the high-speed deposit smart safe of FIG. 1, with a deposit controller guard cover illustrated as semi-transparent for visibility purposes.

FIGS. 11A, 11B, 11C, and 11D show views of a cash storage carousel assembly of the high-speed deposit smart safe of FIG. 1 at four points of operation.

FIG. 12 shows a block diagram of electronics within the high-speed deposit smart safe of FIG. 1.

FIG. 13 shows a flowchart of a process for filling a cash storage carousel of the high-speed deposit smart safe of FIG. 1.

FIG. 14 shows a diagrammatic front view of a cash cassette elevator mechanism with a drop distance sensor of the high-speed deposit smart safe of FIG. 1.

### DETAILED DESCRIPTION

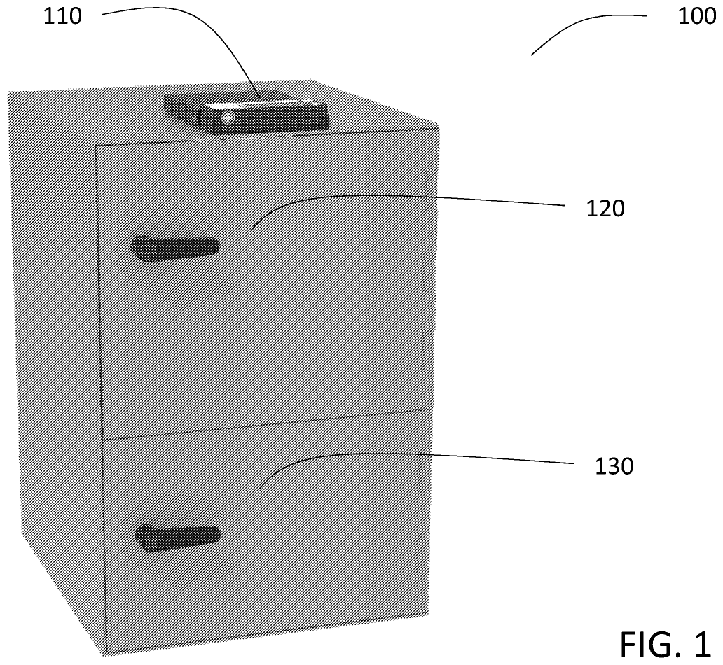

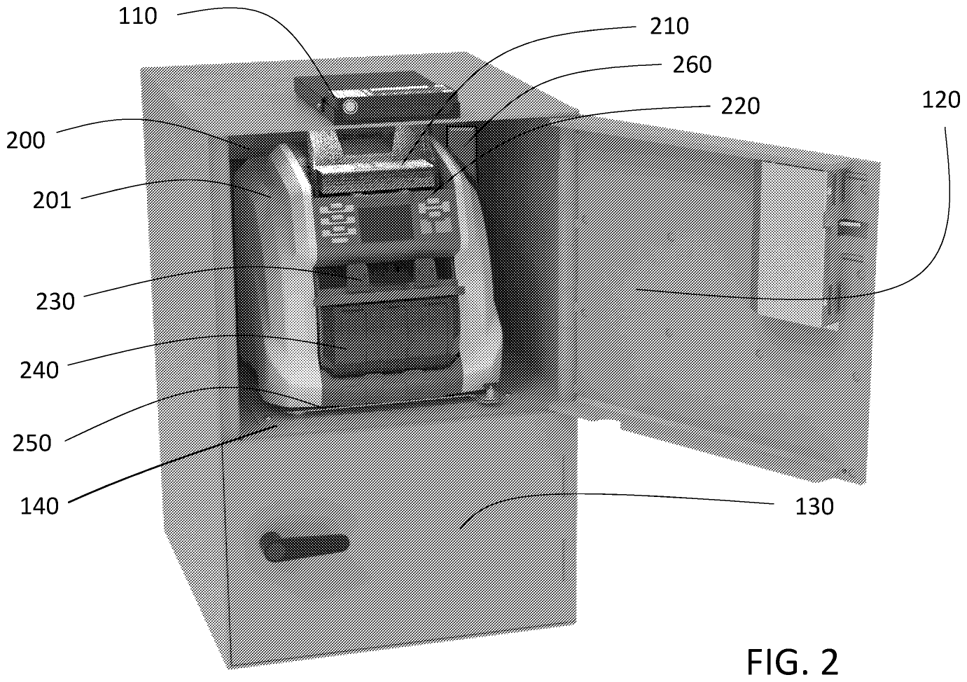

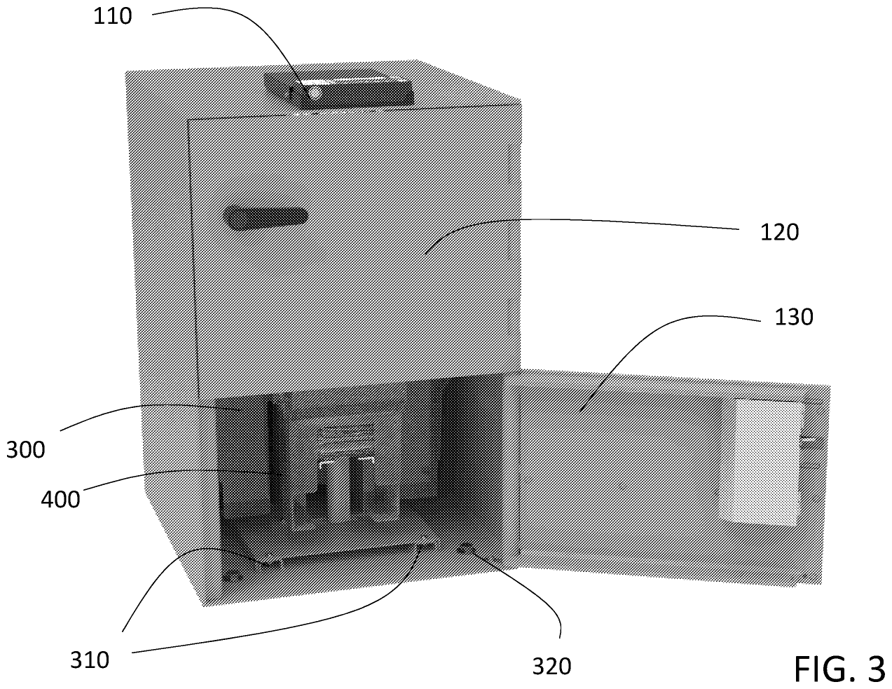

A high-speed deposit smart safe 100 according to the present invention is shown in FIG. 1 in the state of being closed and secured. The smart safe 100 is characterized by having an upper compartment 200 (FIG. 2) with upper door 120 and a lower compartment 300 (FIG. 3) with lower door 130 for selectively and independently accessing the secure areas defined by the respective upper and lower compartments 200, 300. The smart safe 100 includes a user interface 110 mounted to an outer surface of the smart safe 100. The user interface 110 is accessible from outside the secure areas of the safe 100 and is operable to present credentials to open the smart safe 100, to view status information from the smart safe 100, and to configure the smart safe 100. Interface 110 can include a keypad, a display, a graphical user interface, and/or an electronic fob reader, allowing for input from a user for interacting with the safe 100. Authorization of users to the smart safe 100 can be performed in a number of manners, including those described in U.S. Patent Publication No. 2022/0058905A1, which is incorporated herein by reference in its entirety. In some embodiments, user interface 110 may include a touchscreen with graphical menus, and/or may include wired or wireless links to smart phone or tablet devices with communications over secured, encrypted protocols, such that the user can interact through the user interface 110 and/or an external smart device.

To begin a session to deposit a bundle of banknotes, a user must authenticate with interface 110 and have suitable credentials to access compartment door 120. Behind door 120 and within upper compartment 200 is a high speed banknote validator 201 seen in FIG. 2. Banknote validator 201 is of the variety of validators sometimes referred to as one-pocket banknote sorters widely used in bank branch and casino cash rooms as tabletop cash processing units, but is modified with a deposit function that drops notes below the machine into, e.g., a loose deposit bag positioned beneath the machine. Examples of these types of commercially available validators include, e.g., Giesecke & Devrient's PRONOTE® VM, Ribao's DM-150D, Grace's GDM-100, GRG Banking's CA-10, and Glory's DE-50, although it should be understood that other validators could be used.

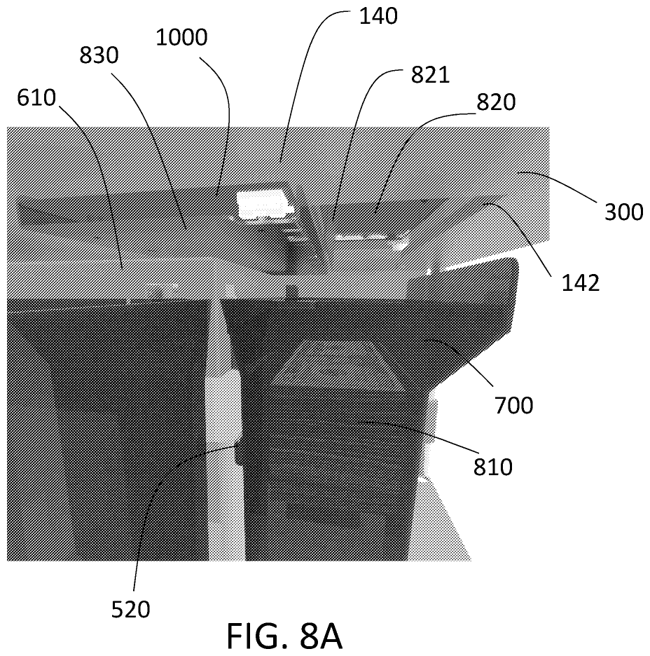

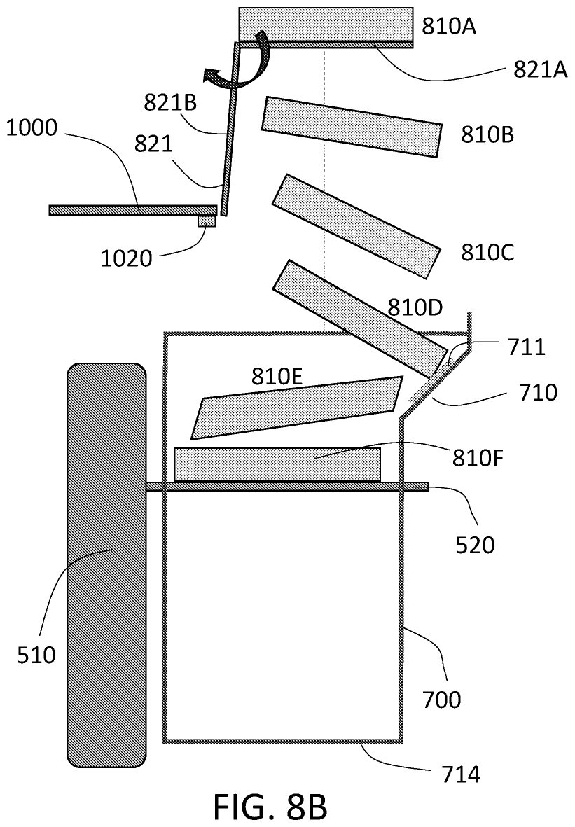

The banknote validator 201 includes a hopper 210 where the banknote bundle is first placed by the operator. The hopper 210 therefore provides a platform configured to receive and support the banknote bundle thereon. The safe controller 260, positioned behind validator 201, is configured to send commands to the validator and receive data back from the validator 201. The validator 201 includes a local user interface panel 220 to indicate status information to the customer and to function as a backup control method for the validator 201 during service or when the safe controller 260 link to the validator 201 requires bypassing. The bundle of banknotes passes from the note hopper 210 to a note escrow area 240 positioned over the drop door 821 (FIGS. 8A and 8B) of the validator 201. The validator 201 is, in turn, positioned on a shelf 140 of the safe 100 separating the upper compartment 200 from the lower compartment 300 (FIG. 2). The banknote validator 201 can be positioned on the shelf 140 such that the note escrow area 240 and the drop door 821 of the validator 201 is positioned over and/or aligned with an opening 142 formed in the shelf 140 of the safe 100, such that bundles of notes released from the validator 201 through the drop door 821 would fall through the opening 142 in the shelf 140 (see, e.g., FIGS. 8A and 8B). Any rejected notes due to counterfeit or poor note fitness are delivered to the note reject area 230. The entirety of the validator 201 assembly is mounted to interface plate 250 which contains a passageway opening 820 to the note storage area (e.g., defined by the space within the lower compartment 300) discussed in further detail in FIGS. 8A and 8B. In some embodiments, the interface plate 250 can be rotatable, allowing easy service access to the rear of validator assembly 201 without having to remove the validator from the upper compartment 200.

The exemplary safe 100 includes a secure upper compartment 200 for storing the high-speed validator 201. This advantageously provides complete protection of the validator 201 and controller 260 electronics against theft, unauthorized use, and accidental damage when not in use. In some embodiments, the safe 100 can enclose the high-speed validator 201 in a manner that maintains it entirely open to the operator at all times for added convenience. In some embodiments, the safe 100 can partially enclose the validator 201 such that only portions of the high-speed validator 201 can be made available/accessible to the operator at all times (e.g., the note hopper 210, the note reject area 230, and/or the escrow door area 240 remaining accessible to the operator at all times). In such embodiments, the door 120 can include one or more openings aligned with the corresponding areas of the validator 201 such that only access to the desired areas is provided through the respective openings in the door 120. In some embodiments, rather than the door 120, the upper compartment 200 can remain open and non-accessible portions of the validator 201 can be protectively wrapped in a metal and/or plastic housing for security or to avoid unintentional damage.

The lower compartment 300 (as shown in FIG. 3) includes a cash storage carousel assembly 400 mounted to a pair of channels 310 in the floor of the smart safe 100 with bolts. The channels 310 can extend substantially parallel to the side walls of the safe 100, and can be spaced from each other by a distance corresponding to the dimensions of the base of the carousel assembly 400 such that the carousel assembly 400 can be molted to the channels 310. The smart safe 100 is itself mounted to the floor of a retail establishment with floor anchors 320 positioned at the corners of the safe 100. The floor anchors 320 pass through openings in the base wall of the safe 100 within the lower compartment 300 to avoid tampering with the floor anchors 320 when the door 130 is closed and locked.

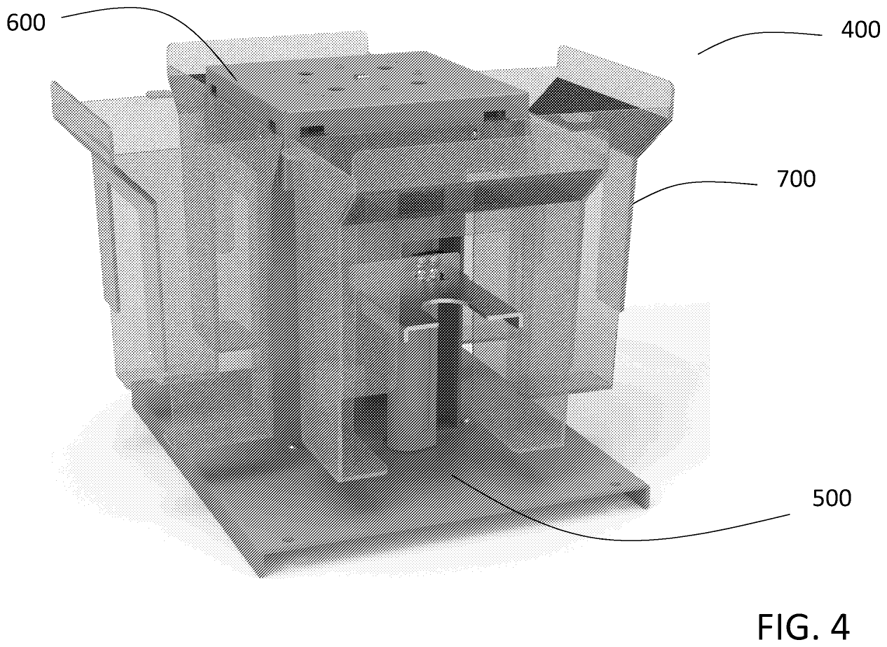

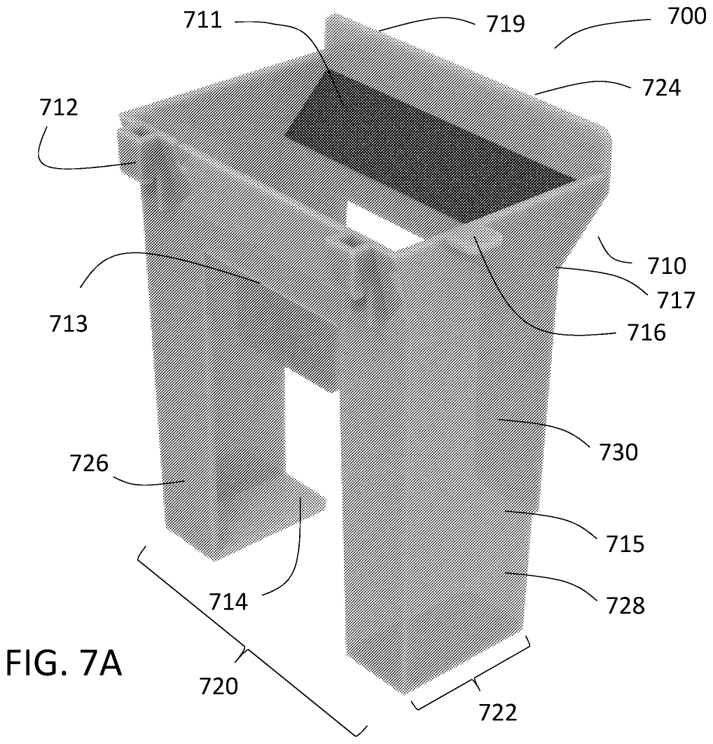

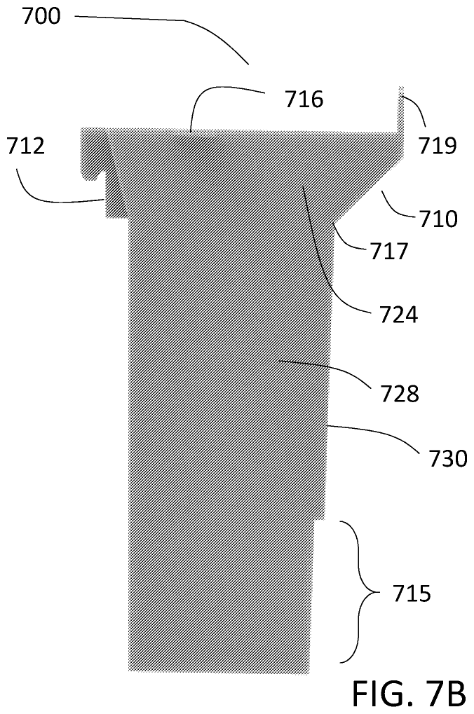

Cash storage carousel assembly 400 has a rotatable carousel 600 of cash cassettes 700 sitting on top of a static base 500 as shown in FIG. 4. Carousel 600 can hold one or more cash cassettes 700 (see FIGS. 7A and 7B). Although illustrated as supporting four cash cassettes 700, each disposed at about 90° relative to each other, the carousel 600 can be configured to support more or less cassettes 700 at different radial distances from each other. The carousel 600 is also capable of operating with only one, two, or three cassettes 700, as desired by the user. Each cash cassette 700 stores orderly stacks of banknotes and is capable of holding approximately 1,000 notes each. Therefore, the deposit assembly with four cash cassettes 700 has a total capacity of about 4,000 notes. As each cassette 700 is filled, the carousel 600 can be rotated to allow for the next cassette 700 to be used. In some embodiments, for lower cash volume customers, the cash storage assembly 400 can include the static base 500 with an affixed cash cassette 700 positioned thereon to catch falling cash bundle deposits (e.g., without a rotating carousel 600). The rotatable configuration of the carousel assembly 400 allows for a larger number of notes to be receives by the respective cassettes 700, while maintaining the entire assembly 400 within a compact volume and/or height.

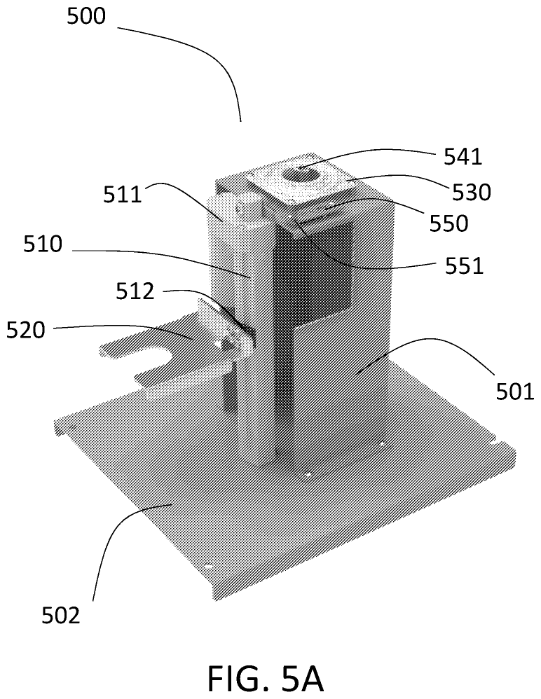

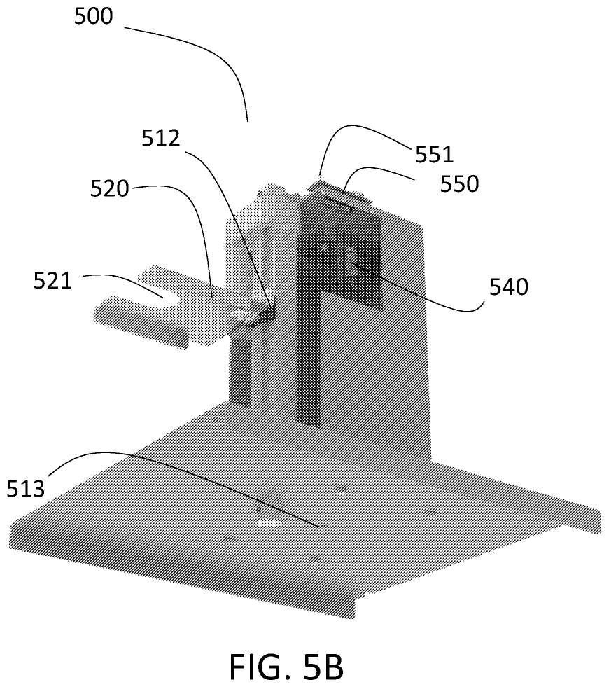

A more detailed view of static base 500 of the deposit assembly 400 is shown in FIGS. 5A and 5B. The mounting base 502 is configured to slide over channels 310 in the base of the smart safe 100 within compartment 300 (see, e.g., FIG. 3). On top of the base 502 is mounting pillar 501 which is affixed to base 502 with four screws. The pillar 501 extends substantially perpendicularly relative to the top, planar surface of the base 502. The pillar 501 can define a substantially rectangular configuration with a hollow interior. In some embodiments, the pillar 501 can include three side walls with one side fully exposed between a top surface and opposing bottom surface of the pillar 501. At the top of the pillar 501, carousel motor 540 is attached with mounting screws. The motor 540 can be mounted to an inner surface of the top wall of the pillar 501, and can be disposed completely within the hollow interior of the pillar 501. The output shaft of motor 540 can extend through an opening in the top wall of the pillar 501, and is coupled to square driver 541 which is positioned through the center of a rotatable square bearing turntable 530. The turntable 530 is therefore rotatably mounted at or immediately adjacent to the top wall of the pillar 501.

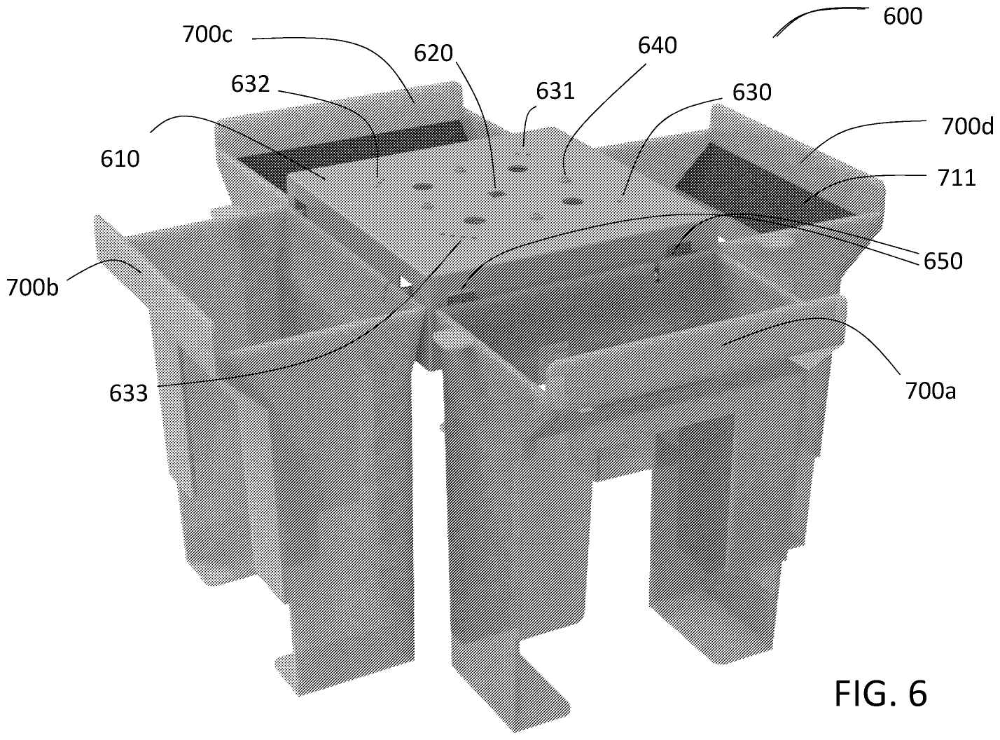

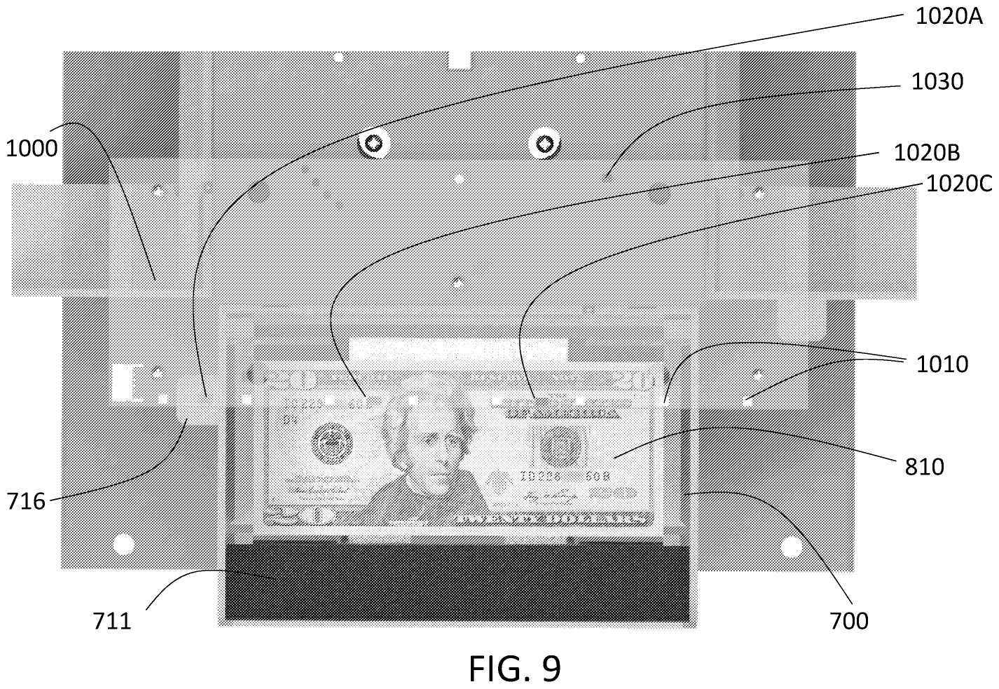

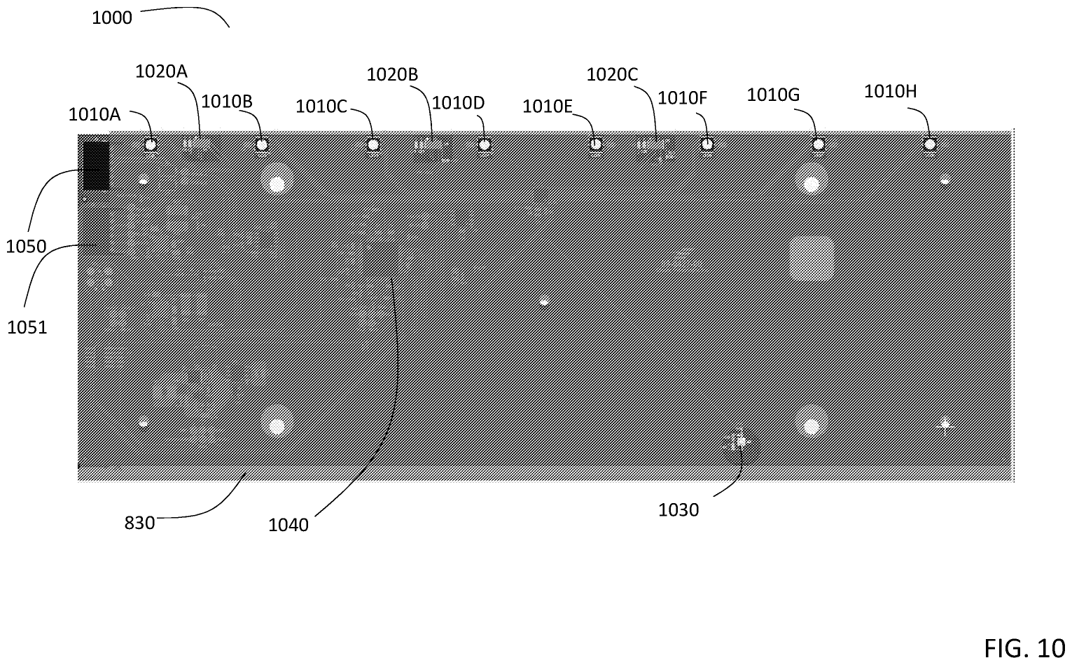

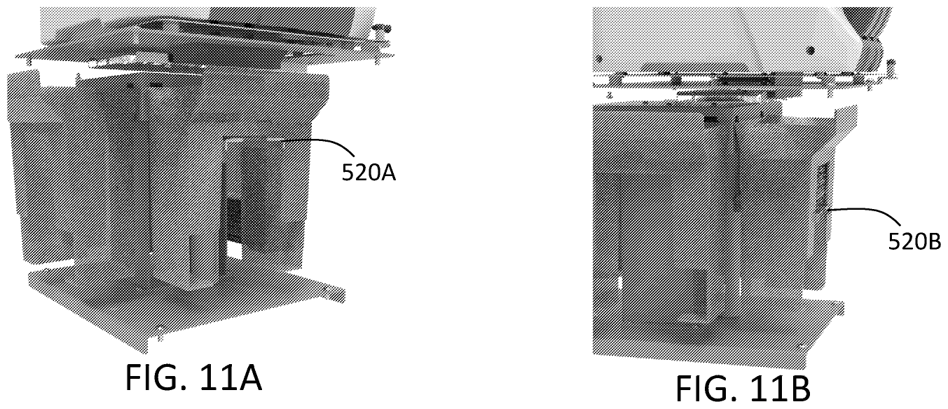

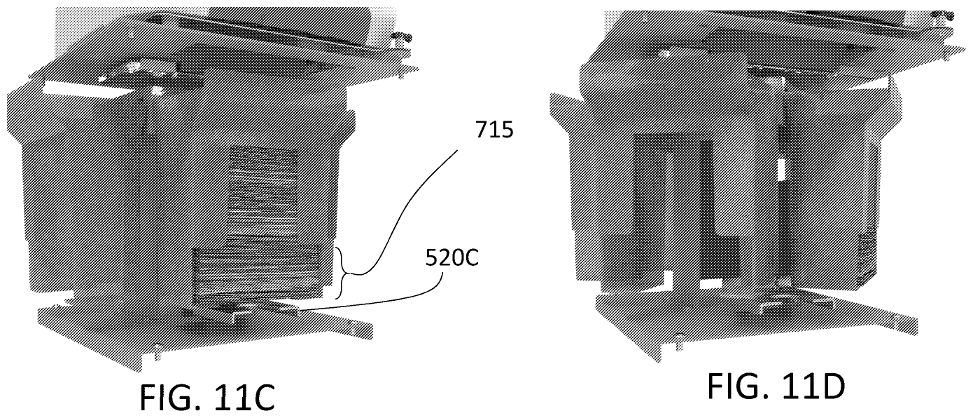

A linear actuator 510 is mounted to the base plate 502 adjacent to the pillar 501 (e.g., adjacent to the side of the pillar 501 lacking a side wall, and thereby facing the hollow interior of the pillar 501). The actuator 510 extends substantially perpendicularly relative to the base 502. The actuator 510 is configured to raise and lower elevator platform 520 slidably attached to the actuator 510 at the moveable junction 512 with mounting screws. Motion of the elevator platform 520 is within a range of approximately 7″ driven by linear actuator motor 511, however, it would be understood that an elevator platform 520 with a smaller or greater linear travel range can be used. The motor 511 can selectively drive translation or sliding of the platform 520 along a complementary track of the actuator 510 to ensure consistent up and down motion relative to the planar top surface of the base 502. The elevator platform 520 is used to adjust the drop height of bundled banknotes deposited from the validating unit above it. The platform 520 includes a substantially planar supporting surface with an opening 521 formed therein. The opening 521 extends from the distal end of the platform 520 and defines a substantially semicircular configuration extending in the direction of the junction 512. The opening 521 in the elevator platform 520 allows for easier collection of banknotes from each cassette 700 by clearing space for a thumb and/or finger(s) to grip bundles of notes from underneath the cassette 700 (discussed in further detail with respect to FIG. 11C). Motor interface circuit board 550 is mounted on top of pillar 501 and serves to receive motor control signals from the deposit controller 1000 for powering motors 540 and 511. Circuit 550 includes emitter 551 positioned vertically to shine light through the carousel support plate 610 through light encoder openings 630, 631, 632, 633 (see FIG. 6), with such light detected and interpreted by light receiver 1030 (see FIGS. 9 and 10), which is discussed in further detail below. Based on light detected by the light receiver 1030, the radial position/orientation of the carousel 600 can be determined.

Carousel 600 (shown in FIG. 6) is positioned on top of static base 500 with the square output driver 541 associated with the carousel motor 540 engaging a centrally located square hole 620 within the carousel support plate 610. The hole 620 and the square output driver 541 can be substantially aligned along a central longitudinal axis of the deposit assembly 400. Four screws 640 can be used to hold the support plate 610 to turntable 530. The support plate 610 can define a substantially square configuration with sidewalls extending downwardly from a top surface to define a hollow interior accessible from a bottom of the support plate 610. The hollow interior can be configured and dimensioned to at least partially receive the top of the pillar 501 and associated motor 540 assembly, such that the carousel 600 can be mounted to the top of the pillar 501. The support plate 610 includes light encoder openings 630, 631, 632, 633 formed in the top surface and radially aligned with each of the four corners of the support plate 610. Each of the encoder openings 630, 631, 632, 633 can include one or more openings or a group of openings (e.g., one, two, three, or four openings), with the respective group of openings radially spaced about 90° from each other. As discussed below, having a different number of openings at each of the corners can provide for additional information to the controller regarding the orientation of the carousel 600. Cash cassettes 700 are mounted to the carousel support plate 610 with fasteners 650. Fasteners 650 can be configured to be removeable (such as hook features, or the like), or the fasteners 650 can be non-removeable (such as screws, fabricated integral with support plate 610 as one injection molded plastic assembly or single metal weldment, or the like).

Four cash cassettes, 700a, 700b, 700c, 700d are illustrated as being mounted to the respective sides of a square shaped support plate 610. It should be recognized that other shaped support plates could be produced to accommodate different arrangements of cash cassettes 700 (such as a triangle for three cassettes 700 or a pentagon for five cassettes 700). In this manner, it is possible to add multiple cash cassettes 700 around the carousel 600 to increase or customize the storage capacity of the smart safe 100 to high capacities while maintaining a short overall height of the safe 100. In some embodiments, the overall height of the smart safe 100 can be less than about 31″ such that the safe 100 is able to fit underneath retail countertops conforming to American with Disabilities Act (ADA) requirements.

Looking closer at cash cassette 700 in FIGS. 7A and 7B, each cassette is constructed of a rigid or semi-rigid material (such as plastic or metal), and is characterized by having a width 720 dimension slightly larger than that of the banknote's length and a depth 722 at the base 714 slightly wider than a banknote's width. The base 714 or bottom end of the cassette 700 is therefore configured complementary to receive a stack of banknotes. The height dimension (as measured between the base 714 and an upper limit 717 of the cassette 700) is selected based on the desired cash storage capacity. A nominal height of 8″ is sufficient to store approximately 1,000 notes per cassette 700 and is compatible with an 7″ linear actuator. However, it should be recognized that taller or shorter cassettes 700 could be used with correspondingly lengthened linear actuators to modify cash storage capacity. The top portion or section 724 of the cassette 700 flairs out with ramp 710 to catch the falling banknotes released from the escrow portion of validator 200 positioned above the cassette 700. In particular, the support sections 726, 728 that receive and support banknotes can define the volume in which banknotes are stored up to the upper limit 717, with the sections 726, 728 generally defining a uniform width 720 and depth 722. The ramp 710 can extend outwardly from the edge associated with the upper limit 717 at the front side of the cassette 700. The top edge of the top section 724 defines an opening such that banknotes can be dropped into the cassette 700. A flange 719 can extend vertically from a top edge of the ramp 710 (and generally from the top edge of the cassette 700) along the entire front surface of the cassette 700. The flange 719 can provide an additional barrier to banknotes falling into the cassette 700. In some embodiments, ramp portion 710 can include a rough surface 711 (e.g., at the interior surface of the ramp 710) to increase the friction between the edge of the banknotes dropping into the cassette 700 and the cassette 700 wall, which aids to neatly stack the falling bundle before tumbling onto the elevator platform 520 that rides inside the height of the cash cassette 700. In some embodiments, a textured coating can be applied to the inner surface of the ramp 710. In some embodiments, a textured material (e.g., adhesive sandpaper, or the like) can be adhered to the inner surface of the ramp 710. The grit or roughness of the rough surface 711 can be selected to sufficiently engage with the falling banknotes to change the pivot direction of the banknotes (discussed in greater detail below).

The elevator platform 520 (FIG. 5A) rides inside opening 713 and extends into the opening 713 from the rear face of the cash cassette 700. In particular, the cassette 700 can define a substantially upside-down U-shaped configuration, with a top section 724 and two support sections 726, 728 extending downwardly from the top section 724. The support sections 726, 728 are spaced from each other to define the opening 713 within which the elevator platform 520 can vertically travel. When the cassette 700 is empty, the elevator platform 520 is positioned near the top of the cassette 700 (e.g., near the uppermost part of opening 713) to limit the height of the banknote bundle drop. Upon each successive banknote bundle deposit into the cassette 700, the elevator platform 520 is actuated to automatically move lower down within opening 713 until the elevator platform 520 falls below base 714 of the cassette 700, at which time the note bundle is supported entirely by the cassette 700 (e.g., by the base 714 in the sections 726, 728), and the elevator platform 520 is free of mechanical interference when the carousel 600 rotates in the plane above the elevator platform 520 (more clearly described with respect to FIG. 11D).

On the front, lower face of cassette 700 is opening 715 (formed in sections 726, 728) which extends approximately 2 inches in height up from base 714 and allows for easy removal of cash from the cassette 700 during a cash collection (more clearly described with respect to FIG. 11C). In particular, the front face of the support sections 726, 728 includes flanges 730 that extend towards each other to reduce the opening 713 width between the support sections 726, 728. These flanges 730 maintain the bundles stacked neatly within the hollow interior of the support sections 726, 728. The opening 715 at the front, lower face of the support sections 726, 728 provides a wider clearance such that one or more bundles can be removed from the support sections 726, 728 through the opening 715. At the top, rear of the cassette 700 are the mounting features 712 that engage with the carousel support plate 610. In some embodiments, the mounting features 712 can include hooks which allow for easy removal and installation of the cassettes 700 onto the carousel. A flange 716 is located at the top of the cassette 700, extending from a side surface of the cassette 700, and can be used as a position indicator for the deposit controller to detect the presence of an installed cassette 7000, as will be discussed below.

Carousel 600 is rotated to a valid cash deposit position when one of the attached cash cassettes 700 is aligned to the elevator platform 520 such that the platform 520 fits through the cassette's elevator opening 713. To ensure proper alignment, deposit controller 1000 (see FIGS. 8A, 8B and 9) receives light from emitter 551 (FIG. 5A) when the light passes through the openings 630-633 in carousel support plate 610 (FIG. 6) and hits receiver 1030 on the controller (FIG. 9). In some embodiments, the light emitter can be in the infrared (IR) wavelengths and the receiver can be optimized for receipt of IR light, thus rejecting visible light that may otherwise be present in the bottom compartment 300. In some embodiments, the opening 630, 631, 632, 633 include patterns that all appear different to the deposit controller 1000 while spinning the carousel 600, so absolute position of each stopping point of the carousel 600 can be determined. In some embodiments, this can be achieved by a different number of perforated holes to produce unique patterns of light and dark detected light on receiver 1030 while spinning of the carousel 600. For example, one corner/position can include a single opening 630, another corner/position can include two openings 631, another corner/position can include three openings 632, and another corner/position can include four openings 633. Based on light detected through the respective opening(s) 630-633, the controller 1000 can determine that the carousel 600 has been aligned with the elevator platform 520. Based on the number of openings detected (e.g., one, two, three or four), the controller 1000 can determine the radial orientation of the carousel 600. In some embodiments, other carousel 600 positioning schemes can be employed by the deposit controller 1000, including a rotational encoder on the carousel motor, magnetic rotational position sensors, hall sensors positioned above magnets at the end stops, and/or other external encoders providing absolute positioning feedback.

Control of the height of elevator plate 520 can be driven from deposit controller 1000 by monitoring feedback/signals transmitted to the controller 1000 from banknote stack height sensors 1020B and 1020C (FIG. 9). The sensors 1020B, 1020C can be mounted to the bottom surface of the shelf 140 within the safe 100 such that the same pair of sensors 1020B, 1020C can be used for detection of the drop distance for each of the respective cassettes 700 as the carousel 600 is rotated into position. In some embodiments, these sensors 1020B, 1020C can be light detection and ranging (Lidar) style sensors which measure the precise distance between the top of the banknote stack and the control board surface using light beams. In some embodiments, the sensors 1020B, 1020C can be ultrasonic distance detectors and/or reflective light sensors that infer distance using the magnitude of the received signal. In some embodiments, only a single sensor 1020B, 1020C can be used. In some embodiments, at least two sensors 1020B, 1020C can be used. In embodiments having two sensors 1020B, 1020C, the sensors 1020B, 1020C can be positioned above both the right and left sides of the banknote stack (e.g., spaced from each other) to determine if there are folds, jams or otherwise disorganized note stacks that require service attention. Discrepancies in the measured height can thereby be detected and an alert can be issued to the operator to correct any potential issues with the banknote stack. In some embodiments, the stack height sensors 1020B, 1020C can be used to periodically monitor the banknote stack height during periods of time where the equipment is secured and idle. Deviations in stack height during what should be idle time would indicate the possibility of malicious tampering with the banknote stack and corresponding alerts can be sent to the safe controller of the tamper. In some embodiments, the stack height sensors 1020B, 1020C can be used with non-removeable cash cassettes, and are positioned above the cash cassette during a collection. In such embodiments, feedback can be given to the operator if the cassette 700 is not completely emptied, as evidenced from the sensor 1020B, 1020C measurement registering less than the full height of the empty cassette 700. Although two stack height sensors 1020B, 1020C are shown, in some embodiments, a single sensor could be used to provide a lower cost system. In some embodiments, a larger number of position height sensors (e.g., three or more sensors) could be used to detect more nuanced bill jams or misorientations.

A third position sensor 1020A can be located above cash cassette flange 716 (e.g., mounted to the bottom surface of the shelf 140) to detect the presence of an installed cash cassette 700 below the drop zone of validator 201. In some embodiments, this sensor 1020A can also be a distance measuring sensor, such as Lidar, configured to sense when the flange 716 appears at a distance of approximately 2″ below the sensor 1020A. In some embodiments, this sensor 1020A can also be used to determine precise alignment of the carousel 600 underneath the drop zone to accomplish the same goals as the previously described light emitter 551 positioning method. For proper position feedback, deposit controller 1000 is mounted to the underside of the shelf 140 separating the upper and lower compartments of the smart safe 100 just behind the deposit drop passageway opening 820 in the shelf (FIG. 8A). The controller 1000 is protected by a guard plate 830 that has openings in it to allow sensor signals, lighting, and cabling to pass through.

When the escrow compartment 240 of the validator fills with the prescribed note bundle amount, the safe controller commands validator 201 to open its drop door 821 (FIGS. 8A and 8B) allowing the note bundle to fall into cassette 700 below. The bundle first hits the rough surface 711 of incline 710 before falling neatly on top of the existing note stack 810. Note that if the note stack is empty within the cassette 700, the bundle will fall directly on the elevator platform 520 (with the platform 520 initially spaced from the base 714 of the cassette 700). After each bundle is dropped, deposit controller position sensors 1020B and 1020C transmit feedback signals to the deposit controller 1000 representative of the height of the note bundle, and the deposit controller 1000 transmits signals to lower the elevator platform 520 to maintain a consistent drop height for the next deposit. The drop height for each note bundle therefore remains equal or substantially equal for each deposit made into the safe 100.

A combination of three activities helps maintain orderly stacks 810 of notes within the cassettes 700. First, dropping bundles of notes rather than individual notes helps to maintain proper stacking in the cassette 700. Nominally, a bundle size 50 notes is sufficient to assist in an orderly bundle drop. However, the safe 100 can operate with any note bundle size. Secondly, breaking the fall of the note bundle on an inclined ramp 710 with sufficient friction helps to re-stack the notes of bundle that begin to loosen upon falling. In some embodiments, the incline of the ramp 710 can be about 45 degrees and can be covered with a rough material to help grip the edges of the note bundle. In some embodiments, the include of the ramp 710 can be about, e.g., 40-50 degrees inclusive, 40-49 degrees inclusive, 40-48 degrees inclusive, 40-47 degrees inclusive, 40-46 degrees inclusive, 40-45 degrees inclusive, 40-44 degrees inclusive, 40-43 degrees inclusive, 40-42 degrees inclusive, 40-41 degrees inclusive, 41-50 degrees inclusive, 42-50 degrees inclusive, 43-50 degrees inclusive, 44-50 degrees inclusive, 45-50 degrees inclusive, 46-50 degrees inclusive, 47-50 degrees inclusive, 48-50 degrees inclusive, 49-50 degrees inclusive, 40 degrees, 41 degrees, 42 degrees, 43 degrees, 44 degrees, 45 degrees, 46 degrees, 47 degrees, 48 degrees, 49 degrees, 50 degrees, or the like. It should be understood that the angle of the ramp 710 can be varied based on the orientation of the bundle being dropped by the validator (e.g., depending on how the validator orients the bundle). In some embodiments, the ramp 710 angle can be adjustable to allow for the cassette 700 to be used with different validators. In some embodiments, the fixed angle of the ramp 710 can be used with different validators.

Limiting the distance/height the note bundles fall relative to the elevator platform 520 and/or the top of the note stack 810 is also an important component in achieving orderly stacks, with the drop distance dimensioned at about 3 inches. The drop distance is measured as the distance between the opening 142 of the shelf 140 through which the bundles fall and (i) the upper surface of the platform 520 or (ii) the upper surface of the uppermost bundle positioned on the platform 520. The position of the sensors 1020 can substantially align with the location of the opening 142 such that measurement from the sensors 1020 to the upper surface of the platform 520 or the upper surface of the uppermost bundle positioned on the platform 520 is representative of the distance from the opening 142. In some embodiments, a different structural element can be used as a reference point for measuring the drop distance. The controller associated with the platform 520 adjusts the position of the platform 520 to ensure that the drop distance is equal or substantially equal for each bundle drop into the cassette 700. The fixed position of the sensors 1020 allows for accurate determination of the drop distance for each bundle drop event. In some embodiments, the drop distance can be about, e.g., 2.5-3.5 inches inclusive, 2.5-3.4 inches inclusive, 2.5-3.3 inches inclusive, 2.5-3.2 inches inclusive, 2.5-3.1 inches inclusive, 2.5-3.0 inches inclusive, 2.5-2.9 inches inclusive, 2.5-2.8 inches inclusive, 2.5-2.7 inches inclusive, 2.5-2.6 inches inclusive, 2.6-3.5 inches inclusive, 2.7-3.5 inches inclusive, 2.8-3.5 inches inclusive, 2.9-3.5 inches inclusive, 3.0-3.5 inches inclusive, 3.1-3.5 inches inclusive, 3.2-3.5 inches inclusive, 3.3-3.5 inches inclusive, 3.4-3.5 inches inclusive, 2.5 inches, 2.6 inches, 2.7 inches, 2.8 inches, 2.9 inches, 3.0 inches, 3.1 inches, 3.2 inches, 3.3 inches, 3.4 inches, 3.5 inches, or the like. Although the combination of these features can assist with improved operation of the safe 100, it should be understood that only one or two of the three features can be used independently of the other features while still providing improved operation of the safe 100.

FIG. 8B shows a time snap shot diagram of a falling note bundle 810. At a first moment in time, the note bundle 810A is resting in the escrow area on top of the rotatable drop door 821 at horizontal position 821A. After the door 821 is swung open to position 821B, the note bundle 810B begins a freefall towards the cash cassette 700 positioned beneath it. As it falls through the air in positions 810B and C, the bundle begins to loosen and moves slightly horizontally from the momentum of sliding off the drop door 821 incline. At position 810D, the bundle impacts inclined wall 710 of the cassette 700 coated in or covered with a rough surface material 711. Upon impact, the bundle squares its edge and counter rotates at position 810E on its way to the elevator platform 520 at position 810F. For the next drop, the elevator platform 520 position is adjusted downwards so that the drop distance of the next bundle is the same as the first (e.g., 3 inches each time a drop of a bundle is to be made). In particular, the platform 520 position is automatically adjusted such that the drop distance is equal or substantially equal for each bundle 810. For example, the drop distance for the first bundle 810 is the vertical height as measured between the opening 142 and the top surface of the elevator platform 520 (e.g., the initial drop distance). The same drop distance can be achieved after the first bundle 810 (and subsequent bundles 810) have been dropped onto the first bundle supported by the elevator platform 520 by adjusting the platform 520 position downward to ensure that the vertical height as measured between the opening 142 and the top surface of the uppermost bundle 810 supported by the elevator platform 520 is equal to the initial drop distance.

Subsequent bundle deposits will fall on top of the previously stacked notes, rather than on the elevator platform 520 as shown in FIG. 8B. After each drop, Lidar sensors 1020 automatically measure the new bundle distance to the opening 142 and feedback any problems to the deposit controller 1000 for possible elevator motor adjustments. In the event of a significantly unexpected Lidar measurement from either one or multiple Lidar sensors scanning the surface of the note stack, the deposit controller 1000 can, e.g., drive the elevator motor up and down to shake the notes into compliance, lower the elevator platform 520 completely and shake the carousel 600 left and right to assist in settling the notes prior to raising up the elevator platform 520 again to the correct target drop distance, combinations thereof, or the like. After each corrective measure is taken by the deposit controller 1000, the sensors 1020 can measure the drop distance again to determine if a proper or expected drop distance is achieved.

FIG. 8B illustrates a trap door deposit mechanism of the Ribao DM-150D validator where door 821 is built into the high-speed validator assembly 201. In some embodiments, use of other styles of a validator assembly involving motorized deposit mechanisms is possible, whereby bundles are conveyorized out of the validator escrow area and positioned to fall into the cash cassette placed below.

Indicator lights 1010 are located across the front edge of deposit controller 1000 seen in FIGS. 9 and 10, and can be used for illuminating lower compartment 300. In particular, the lights 1010 can be used to illuminate the cash cassette 700 placed most directly in front of an operator during a collection. The lighting elements 1010 can be RGB LEDs that, in some embodiments, can be used to indicate a range of operating states and cues to the operator. For example, when cash is present in the front-facing note cassette 700, LED indicators 1010A-H could be lit bright green. Once the Lidar sensors detect that all the banknotes have been removed from the cassette 700, the indicators 1010A-H can blink green. If banknotes are known to be in the cassette 700 to the right of the front facing cassette 700 after the front cassette 700 is emptied, LED indicators 1010E-H, can blink amber colored to indicate a carousel 600 rotation to the right is necessary, for example. Error conditions detected within the deposit module could result in a red blinking LED light bar of one or all the LEDs. Deposit controller processor 1040 is preferably a microcontroller that runs embedded software but could also be a microprocessor or alternative digital logic controller. The deposit controller's microcontroller communicates with the smart safe controller by way of a cable harness affixed to port 1050. A second port, 1051 electrically connects deposits controller 1000 with the static base of the deposit carousel 500, terminating on motor interface circuit board 550.

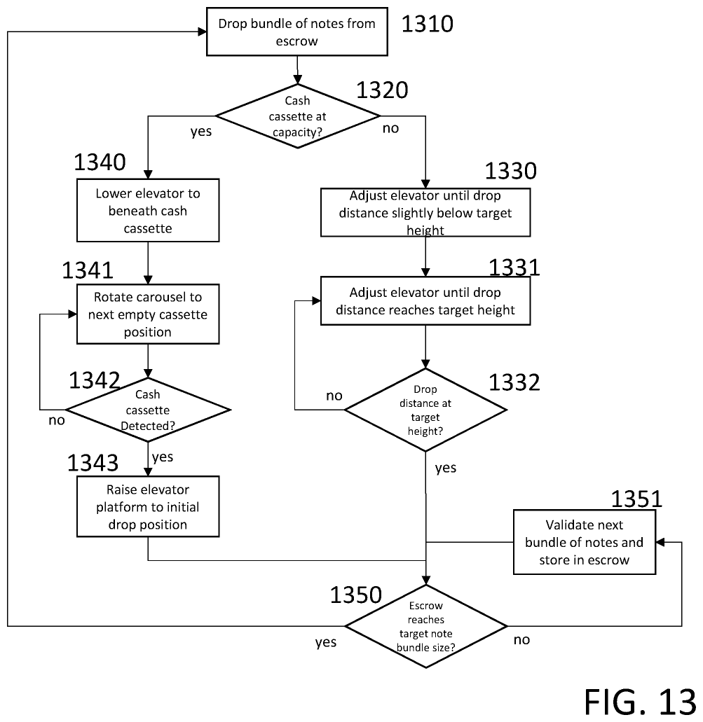

FIGS. 11A-D show four stages in the operation of the deposit carousel assembly. In a first stage in FIG. 11A, the elevator platform is at the initial top position 520A of the banknote cassette 700. As the bundles of banknotes drop down into the cassette 700, the elevator platform adjusts to lower positions, such as position 520B in FIG. 11B, in an effort to maintain the same bundle drop distance for newly deposited banknotes into the cassette 700. Once the cassette 700 is completely filled in FIG. 11C, the elevator platform is positioned at a position 520C below the base of the cassette 700. This is also the position the elevator platform is driven to whenever the lower compartment door 130 is opened by an operator, even if the cassette 700 is not completely full of banknotes. Cutaway 521 in the elevator plate allows for the operator to easily grip bundles of neatly stacked notes through opening 715 (see, e.g., FIG. 7B and FIG. 11C). Finally, in FIG. 11D, the carousel 600 is rotated to position an empty cassette 700 above the elevator platform 520. In particular, by positioning the platform at position 520C, the platform is spaced away from the base 714 of the cassette 700, allowing for the carousel 600 to rotate and reposition the cassettes 700 such that an empty cassette 700 can be oriented and aligned with the platform 520C. This allows for a single elevator platform 520 to be used with each of the cassettes 700 supported by the carousel 600, reducing the overall costs and maintenance associated with the safe 100. Once the empty cassette 700 has been rotated into position and aligned with the platform 520, the platform 520 can be raised into position 520A to begin filling the new cassette 700. Thus, the cycle repeats back to FIG. 11A when the elevator platform is raised to the initial starting height for the new cassette 700. The algorithm used by deposit microcontroller 1060 to drive the elevator platform 520 and carousel 600 is discussed below with respect to FIG. 13.

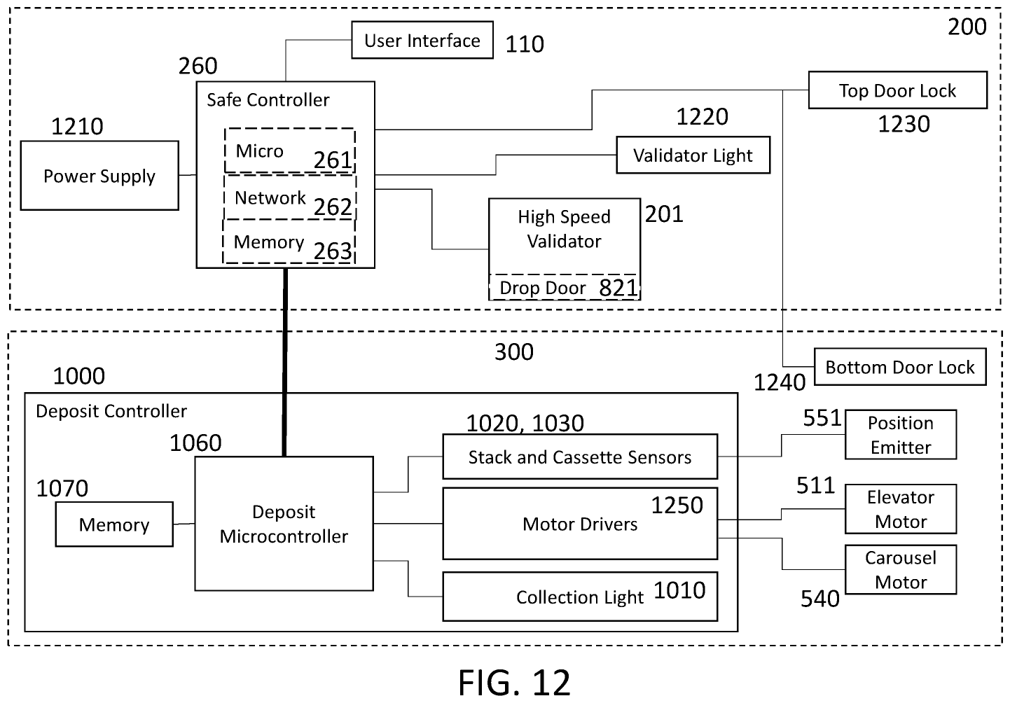

FIG. 12 shows a block diagram of the electronic architecture within the high-speed deposit smart safe 100 according to the present invention. In the upper compartment 200, a power supply 1210 converts AC 110V to a DC supply rail for the smart safe controller 260, which can be 24 VDC. Safe controller 260 features a microcontroller 261, which could alternatively be a microprocessor or other form of digital logic controller, and is responsible for sending commands to the smart safe door locks 1230, 1240, the upper compartment light 1220, the user interface 110, and the high-speed validator 201. The high-speed validator 201 may also include a separate connection to the power supply or direct connection to AC line power. Software within the microcontroller 261 controls the bundle size of notes in the escrow area of 201 and when the control drop door 821 is to open, sending bundles of notes into the cash cassettes 700 below. The safe controller 260 may also have a connection to a network server by way of a LAN connection or cellular link 262 for the purpose of exchanging deposit activity information, configuration information, or firmware updates to update any or all electronics that are part of the smart safe. The controller 260 also features memory 263 in the form of onboard Flash storage, or an external serial flash chip, SD card, or other storage media for the purpose of at least tracking total notes deposited in each cassette by count and by value.

Safe controller 261 sends power and exchanges data with the deposit microcontroller 1060 located on the deposit control board 1000. Power delivered can be 24 VDC, and data exchange can be a serial bus and can be exchanged over various topologies and protocols including RS485, CAN bus, RS232, Ethernet or USB. The deposit microcontroller 1060 manages routines for controlling the elevator motor 511 and carousel motor 540 by way of bidirectional motor drivers 1250. The algorithm for driving motors is informed by sensor feedback from stack height sensors 1020B and 1020C and carousel position sensors 1020A and 1030, along with driving the corresponding carousel position emitter 551. Microcontroller 1060 also controls the collection LED lighting array 1010 to help aid the operator when the bottom door 130 is opened. Local memory 1070 is available on the deposit controller 1060 to persist various firmware parameters, firmware, and deposit assembly status information.

The deposit controller 1060 has responsibility of all deposit assembly behaviors commanded by the safe controller microcontroller 261. Once behaviors are completed, whether successfully or unsuccessfully, the resulting status is reported back to the safe controller microcontroller 261. The interplay between the two controllers during a deposit is illustrated in the flowchart of FIG. 13. In step 1310, microcontroller 261 commands validator 201 to drop the bundle of notes from the escrow area to the cash cassette 700 below. Upon receiving this command, validator 201 opens drop door 821 (FIGS. 8A and 8B). Microcontroller 261 tracks the total notes dropped so far into the cash cassette 700 and, if that level is determined to be less than a maximum cassette 700 threshold in step 1320, (about 1,000 notes) the controller determines there is room for additional bundles to drop.

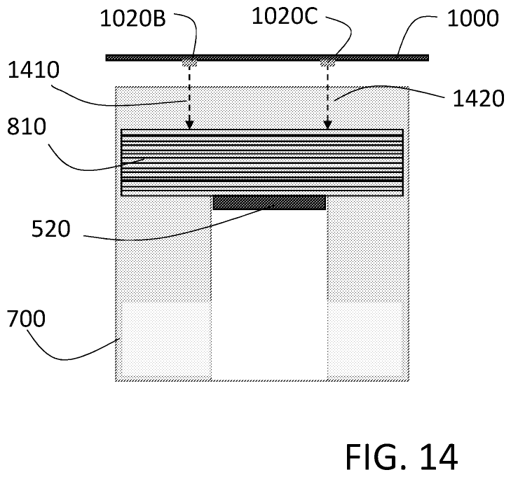

In step 1330, a command is sent from safe microcontroller 261 to deposit microcontroller 1060 to make room for additional note bundles. Deposit microcontroller 1060 drives the elevator platform 520 downwards while monitoring the Lidar sensors measuring the distance between the top of the note stack to sensor. Preferably two Lidar sensors 1020B and 1020C are used to produce two distance measurements 1410 and 1420, as shown in FIG. 14. The average measurement provided between the two of them is considered for the drop distance or height. The elevator platform 520 is driven below the target drop height by a short predetermined distance to allow for scraping of the note stack edges against the side wall of the cassette 700 as the elevator platform 520 raises back to the target height in step 1331. For example, if the drop distance is 3 inches, the elevator platform 520 can initially be driven down below this target drop distance by about 0.5 inches (e.g., 3.5 inches total), and immediately after driven up to the target drop distance of 3 inches. The down and up motion of the elevator platform 520 provides a compressive force to more neatly stack the note bundle, and the scraping action against the side walls of the cassettes 700 can serve to further compress the note bundle, removing some of the air between the banknotes and allowing for increased capacity. In some embodiments, this short overtravel distance can be about 0.5 inches, although other overtravel distances can be used depending on the linear range of the platform 520. Once the target drop height distance is reached in 1332, the deposit microcontroller 1060 sends a drop ready signal to the safe microcontroller 261. If the safe controller has another escrowed bundle waiting in the validator at that time in step 1350, another note bundle will be deposited into the cash cassette, returning to step 1310. Otherwise, it may be necessary for the safe controller to wait for the validator to continue processing new banknotes or for additional cash deposits to be presented to the validator by operators in step 1351.

Returning to step 1320, if after a bundle of notes is dropped, the safe controller determines that the banknote cassette 700 should be at capacity by exceeded a maximum note threshold, the controller will command the deposit microcontroller 1060 to shift to a fresh cassette 700 if one is available. Similarly, the deposit controller can determine itself that it may be at capacity in step 1320 for a given cassette 700 if it determines that its elevator platform 520 is at or near the bottom of travel while the Lidar sensors indicate the note stack is all the way at the top. Once a cassette 700 is full, the deposit microcontroller 1060 drives the elevator platform 520 all the way to the bottom to a resting position below the cassette 700 (see FIG. 11C). The end of elevator platform 520 travel may be determined by way of a limit switch or a position sensor actuated by the motor or the elevator platform 520. Once the elevator platform 520 is at the lowest position and out of the way of the rotatable portion of the carousel assembly 600, the microcontroller controls the carousel motor to rotate in step 1341 in the direction of the next empty cassette 700 location. In particular, the elevator platform 520 is lowered to a position in which clearance for rotation of the carousel 600 and cassettes 700 is provided, allowing for positioning of an empty cassette 700 in aligned with the platform 520. While rotating, in step 1342, sensors are monitored to determine when the next end position is reached. Lidar sensor 1020A is used to detect the presence of a new cassette 700 when the flange feature 716 appears at close distance to the sensor. The pattern of light and dark signals from IR receiver 1030 is also monitored to determine absolute location of the carousel 600 in one of the four end positions. Once it is determined the carousel 600 has positioned a new cassette 700 squarely under the drop zone, deposit microcontroller 1060 will raise the elevator platform 520 to the initial drop position in step 1343 (see FIG. 11A) and signal to the safe controller 261 that it is ready for another deposit.

If there is no space in any of the cash cassettes 700 to accept additional banknotes, controller 1060 will signal to safe controller microcontroller 261 that the deposit assembly is full and a collection is required.

The embodiments described above are considered illustrative only, and should not be viewed as limited to any particular arrangement of features. For example, those skilled in the art will recognize that alternative processing operations and associated system configurations can be used in other embodiments. It is therefore possible that other embodiments may include additional or alternative types of item dispensing systems.

It is also to be appreciated that the particular process steps used in the embodiments described above are exemplary only, and other embodiments can utilize different types and arrangements of processing operations. For example, certain process steps described as being performed serially in the illustrative embodiments can in other embodiments be performed at least in part in parallel with one another.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1. A note bundle deposit system, comprising:
a cassette including a hollow interior configured to receive note bundles, the cassette including an opening extending from a base of the cassette;
a platform capable of being linearly driven in opposing directions along a path such that the platform moves within the opening of the cassette, the platform including a top surface configured to support the note bundles;
at least one sensor configured to detect a drop distance of the note bundles, the drop distance defining (i) a distance between the at least one sensor and the top surface of the platform for a first note bundle introduced into the cassette, and (ii) a distance between the at least one sensor and a top surface of an uppermost note bundle supported by the platform for all subsequent note bundles introduced into the cassette; and
a controller in communication with the at least one sensor to receive the detected drop distance and adjust a position of the platform along the path such that the drop distance is substantially equal for each note bundle introduced into the cassette.

2. The note bundle deposit system of claim 1, wherein the cassette includes a top section and two support sections extending from the top section.

3. The note bundle deposit system of claim 2, wherein the two support sections are spaced from each other by the opening extending from the base of the cassette.

4. The note bundle deposit system of claim 1, wherein cassette includes a top section with an inclined ramp configured to engage with the note bundles falling into the cassette.

5. The note bundle deposit system of claim 4, wherein the inclined ramp extends at an angle of about 45° relative to horizontal.

6. The note bundle deposit system of claim 4, wherein the inclined ramp includes a textured surface for frictional engagement with the note bundles falling into the cassette.

7. The note bundle deposit system of claim 1, wherein the drop distance is between about 2.5 inches to about 3.5 inches, inclusive.

8. The note bundle deposit system of claim 1, wherein the drop distance is about 3 inches.

9. The note bundle deposit system of claim 1, wherein the platform is capable of being linearly driven to a lowermost position of the path such that the platform is disposed below a plane defined by the base of the cassette.

10. The note bundle deposit system of claim 9, wherein the cassette is mounted to a carousel rotatably coupled to a carousel base.

11. The note bundle deposit system of claim 10, wherein when the platform is in the lowermost position, clearance is provided between the platform and the cassette for rotation of the carousel.

12. The note bundle deposit system of claim 1, wherein the at least one sensor includes a first sensor and a second sensor spaced from each other, both the first and second sensors each configured to detect the drop distance.

13. The note bundle deposit system of claim 12, wherein the controller is configured to detect a discrepancy between the drop distance detected by the first sensor and the drop distance detected by the second sensor.

14. The note bundle deposit system of claim 1, wherein the at least one sensor includes a Lidar sensor.

15. A safe, comprising:
an upper compartment configured to receive a validator therein;
a lower compartment disposed beneath the upper compartment and separated from the upper compartment by a shelf, the shelf including an opening formed therein and configured to be aligned with the validator;
a note bundle deposit system disposed within the lower compartment, the note bundle deposit system including:
a cassette including a hollow interior configured to receive note bundles from the upper compartment, the cassette including an opening extending from a base of the cassette;
a platform capable of being linearly driven in opposing directions along a path such that the platform moves within the opening of the cassette, the platform including a top surface configured to support the note bundles;
at least one sensor configured to detect a drop distance of the note bundles, the drop distance defining (i) a distance between the at least one sensor and the top surface of the platform for a first note bundle introduced into the cassette, and (ii) a distance between the at least one sensor and a top surface of an uppermost note bundle supported by the platform for all subsequent note bundles introduced into the cassette; and
a controller in communication with the at least one sensor to receive the detected drop distance and adjust a position of the platform along the path such that the drop distance is substantially equal for each note bundle introduced into the cassette.

16. A method of depositing note bundles, the method comprising:
detecting a drop distance of a note bundle with at least one sensor, the drop distance defining (i) a distance between the at least one sensor and a top surface of a platform of the note bundle deposit system for a first note bundle introduced into a cassette of the note bundle deposit system, and (ii) a distance between the at least one sensor and a top surface of an uppermost note bundle supported by the platform for all subsequent note bundles introduced into the cassette;
introducing the first note bundle into the cassette, the cassette including a hollow interior configured to receive the first note bundle, and the cassette including an opening extending from a base of the cassette;
receiving the first note bundle on the top surface of the platform;
linearly driving the platform along a path such that the platform moves within the opening of the cassette;
receiving at a controller of the note bundle deposit system the detected drop distance from the at least one sensor; and
adjusting a position of the platform along the path such that the drop distance is substantially equal for a subsequent note bundle to be introduced into the cassette.

17. The method of claim 16, comprising driving the platform with the controller to a lowermost position of the path such that the platform is disposed below a plane defined by the base of the cassette.

18. The method of claim 17, wherein the cassette is mounted to a carousel rotatably coupled to a carousel base.

19. The method of claim 18, comprising actuating rotation of the carousel relative to the carousel base, wherein when the platform is in the lowermost position, clearance is provided between the platform and the cassette for rotation of the carousel.

20. A note bundle deposit system, comprising:
a carousel rotatably mounted to a base;
two or more cassettes mounted to the carousel, each cassette of the two or more cassettes including a hollow interior configured to receive note bundles, and each cassette including an opening extending from a base of the cassette;
a single platform mounted to the base and capable of being linearly driven in opposing directions along a path such that the single platform moves within the opening of a first cassette of the two or more cassettes; and
a controller configured to adjust a position of the single platform along the path to a lowermost position such that the platform is disposed below a plane defined by the base of the first cassette;
wherein the controller is configured to rotate the carousel such that the first cassette is moved radially away from the single platform and a second cassette of the two or more cassettes is aligned with the single platform; and
wherein the controller is configured to adjust the position of the single platform along the path to a desired position within the opening of the second cassette.
